(19) United States
(12) Patent Application Publication
(10) Pub. No.: US 2009/0300089 A1
(43) Pub. Date: Dec. 3, 2009

(54) FINITE IMPULSE RESPONSE FILTER AND METHOD

(75) Inventor: Cheng-Hsi HUNG, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX TECHNOLOGIES LIMITED, Tainan County (TW)

(21) Appl. No.: 12/128,688

(22) Filed: May 29, 2008

(51) Int. Cl. G06F 17/10

(52) U.S. Cl. 708/320

(57) ABSTRACT

An N-order finite impulse response (FIR) filter with a symmetric coefficient set is provided. An input device receives a serial of input signals according to a sampling frequency and stores the received data into the first and second memories by turns. A first calculating device reads the N successively received data from the first and second memories according to an operation frequency and generates a plurality of first calculation values, wherein each of the read data corresponds to a coefficient of the symmetric coefficient set and the first calculation value is generated by summing the read data corresponding to the same coefficient. A second calculating device generates a plurality of second calculation values, wherein the second calculation value is generated by multiplying the first calculation value and the corresponding coefficient. A third calculating device accumulates the second calculation values to generate an output signal.

### BACKGROUND OF THE INVENTION

1. Field of the Invention

The invention relates to a finite impulse response (FIR) filter, and more particularly to an FIR filter with a symmetric coefficient set.

2. Description of the Related Art

FIR filters are a type of digital filters used in digital signal processing (DSP) applications. An FIR filter may be configured to be implemented as a high pass filter, a low pass filter or a band pass filter, and the impulse response is finite because there is no feedback in the FIR filter. Generally, a filtering process of an FIR filter is operated by multiplying a series of coefficients with corresponding sampled data of the input signals and then accumulating the results. In addition, values of the FIR coefficients are selected according to the type of filter being implemented, and a filter order of the FIR filter is selected according to a desired performance of the FIR filter.

FIG. 1 shows a conventional FIR filter 100. The FIR filter 100 comprises an SRAM 110, a multiplier 120 and an accumulator 130. A relationship between an input signal x[n] and an output signal y[n] is given by the following formula (1):

y[n]=a₀x[n]+a₁x[n−1]+a₂x[n−2]+ . . . +aₖ₋₁x[n−(k−1)] (1)

where aᵢ are the filter coefficients (0≦i≦k) and k is the filter order. As shown in FIG. 1, the input signals sampled by a frequency f, are stored in the SRAM 110. The multiplier 120 is used to multiply the data stored in the SRAM 110 with the corresponding coefficients according to a frequency f_{c}, wherein the frequency f_{c} is an operation frequency of the SRAM 110 and the frequency f_{c} divided by the frequency fₛ is greater than or equal to k (i.e. f_{c}/fₛ≧k). For example, if the FIR filter 100 is a 4-order FIR filter, the multiplier 120 uses 4 cycles of the frequency f_{c} to calculate a₀×x[n], a₁×x[n−1], a₂×x[n−2] and a₃×x[n−3], and obtains 4 multiplying results according to the calculations. The accumulator 130 receives and accumulates the multiplied results to obtain the output signal y[n]. For the output signal y[n], the multiplying and accumulating calculations of the formula (1) must be completed within the frequency fₛ, which is a sampling rate of the FIR filter 100.

### BRIEF SUMMARY OF THE INVENTION

Finite impulse response (FIR) filters and method are provided. An exemplary embodiment of such an N-order FIR filter comprises first and second memories, an input device, first, second and third calculating devices. The input device receives a serial of input signals according to a sampling frequency and stores the received data into the first and second memories by turns. The first calculating device reads the N successively received data from the first and second memories according to an operation frequency and generates a plurality of first calculation values, wherein each of the read data corresponds to a coefficient of the symmetric coefficient set and the first calculation value is generated by summing the read data corresponding to the same coefficient. The second calculating device generates a plurality of second calculation values, wherein the second calculation value is generated by multiplying the first calculation value and the corresponding coefficient. The third calculating device accumulates the second calculation values to generate an output signal.

Furthermore, an exemplary embodiment of a method for implementing an N-order finite impulse response (FIR) filter with a symmetric coefficient set is provided. The method comprises: receiving a serial of input signals according to a sampling frequency; storing the received data into a first memory and a second memory by turns; reading the N successively received data from the first and second memories according to an operation frequency, wherein each of the read data corresponds to a coefficient of the symmetric coefficient set; summing the read data corresponding to the same coefficient to generate a plurality of first calculation values, respectively; multiplying the first calculation values and the corresponding coefficients to generate a plurality of second calculation values, respectively; and accumulating the second calculation values to generate an output signal.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a conventional FIR filter;

FIG. 2 shows an N-order finite impulse response (FIR) filter with a symmetric coefficient set according to an embodiment of the invention;

FIGS. 3A and 3B show a storing scheme of RAM 0 and RAM 1 when N is even;

FIGS. 4A and 4B show a storing scheme of RAM 0 and RAM 1 when N is odd; and

FIG. 5 shows a method for implementing an N-order FIR filter with a symmetric coefficient set according to an embodiment of the invention.

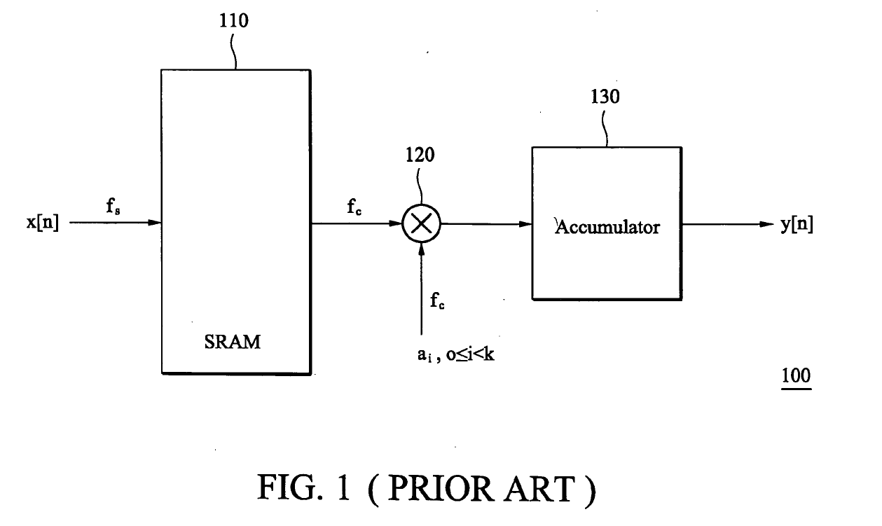

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

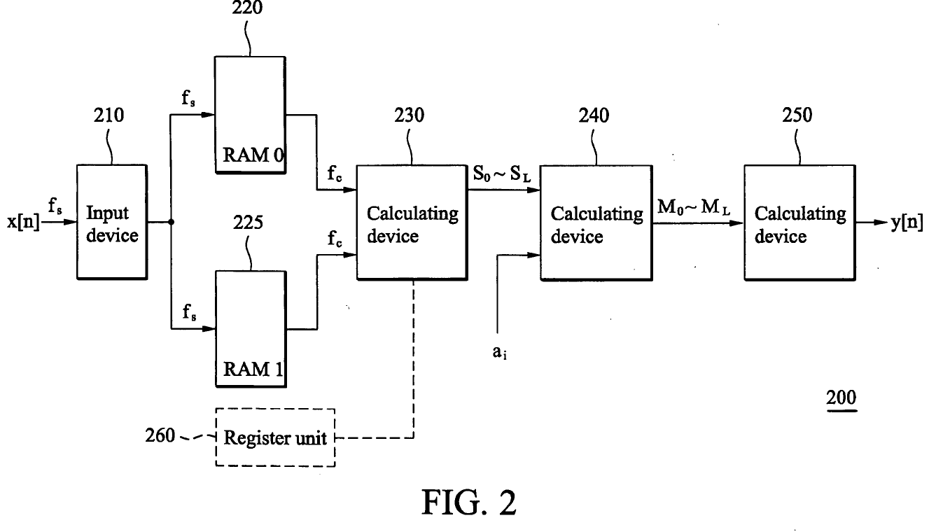

FIG. 2 shows an N-order finite impulse response (FIR) filter 200 with a symmetric coefficient set according to an embodiment of the invention. The FIR filter 200 comprises an input device 210, a memory 220 (i.e. RAM 0), a memory 225 (i.e. RAM 1) and three calculating devices 230, 240 and 250. A relationship between an input signal x[n] and an output signal y[n] is given by the following formula (2):

y[n]=a₀x[n]+a₁x[n−1]+ . . . +a_{N-2}x[n−(N−2)]+a_{N-1}x[n−(N−1)] (2)

where aᵢ are the filter coefficients (0≦i<N and i is an integer) and N is the filter order. In the formula (2), aᵢ=a_{N-i-1} due to the FIR filter 200 being a symmetric filter which has symmetric coefficients. Hence, the relationship between an input signal x[n] and an output signal y[n] is rewritten as the following formula (3):

y[n]=a₀x[n]+a₁x[n−1]+ . . . +a_{N-2}x[n−(N−2)]+a_{N-1}x[n−(N−1)] (3)

In FIG. 2, the input device 210 receives a serial of input signal x sampled by a frequency fₛ in sequence and stores the received data into the memories 220 and 225 by turns, wherein the memory 220 and the memory 225 are the same type of memories which have an operation frequency f_{c}. The calculating device 230 reads the N successively received data (i.e. x[n], x[n−1], . . . x[n−(N−1)]) from the memories 220 and 225 according to the operation frequency f_{c}, wherein each read data corresponds to a coefficient of the formula (3). For example, the data x[n] corresponds to the coefficient a₀, the data x[n−1] corresponds to the coefficient a₁ and the data x[n−(N−1)] corresponds to the coefficient a₀. Then, the calculating device 230 separately sums up the read data which correspond to the same coefficient to obtain a plurality of calculation values S₀-S_{L}, as shown in the following:

$$\begin{matrix}{S}_{0} = x [ n ] + x [ n - ( N - 1 ) ] \\ {S}_{1} = x [ n - 1 ] + x [ n - ( N - 2 ) ] \\ ⋮\end{matrix}$$

In this embodiment, N is even,

$${S}_{L} = x [ n - ( \frac{N}{2} - 1 ) ] + x [ n - \frac{N}{2} ] ,$$

wherein L is equal to

$$( \frac{N}{2} - 1 ) .$$

In another embodiment, N is odd,

$${S}_{L} = x [ n - ( \frac{N - 1}{2} - 1 ) ] + x [ n - ( \frac{N - 1}{2} + 1 ) ] ,$$

wherein L is equal to

$$( \frac{N - 1}{2} - 1 ) .$$

If N is odd, the FIR filter 200 further comprises a register unit 260 to store a data

$$x [ n - \frac{N - 1}{2} ] ,$$

which is a middle data between the N successively received data. Specifically, the middle data is a

$$( \frac{N + 1}{2} ) th$$

data of the N successively received data and corresponds to an asymmetric coefficient. Then, the calculating device 240 multiples the calculation values S₀-S_{L} and the corresponding coefficients a₀-a_{L} to generate a plurality of calculation values M₀-M_{L} respectively, as shown in the following:

$$\begin{matrix}{M}_{0} = {a}_{0} \times {S}_{0} \\ {M}_{1} = {a}_{1} \times {S}_{1} \\ ⋮ \\ {M}_{L} = {a}_{L} \times {S}_{L}\end{matrix}$$

Finally, the calculating device 250 accumulates the calculation values M₀-M_{L} to generate the output signal y[n] corresponding to the input signal x[n]. In this embodiment, the operation frequency f_{c} divided by the sampling frequency fₛ is greater than or equal to N.

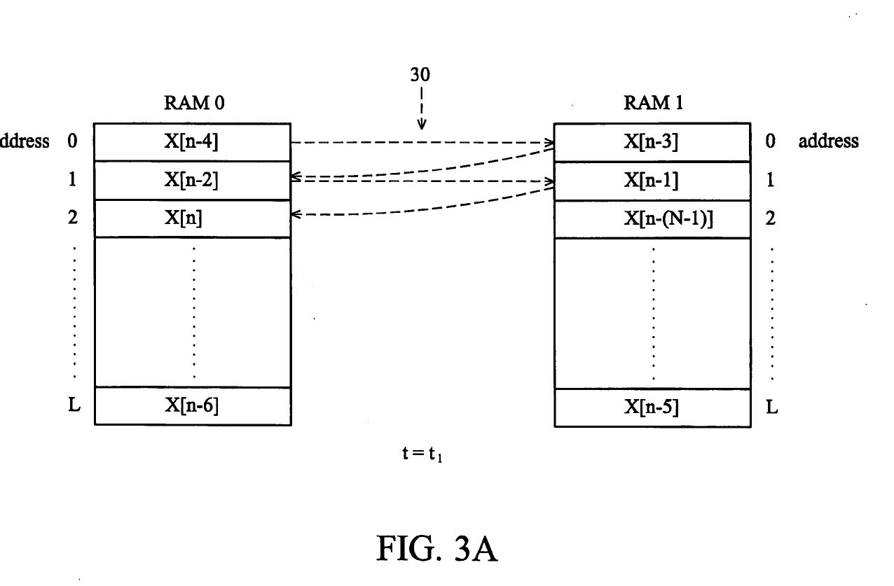

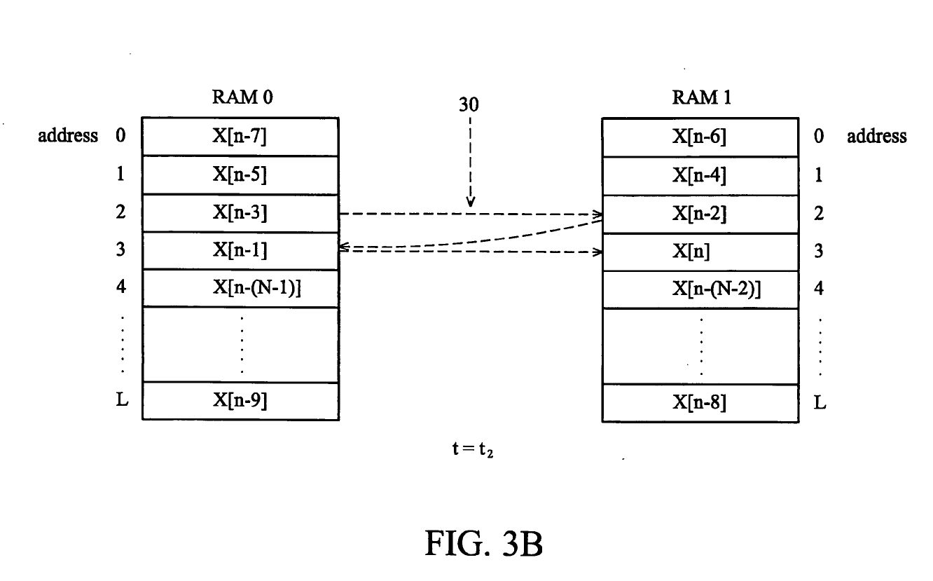

FIGS. 3A and 3B show a storing scheme of RAM 0 and RAM 1 when N is even. As described above, the input device 210 writes the successively received data into the RAM 0 and RAM 1 by turns. FIG. 3A shows a storing status of the received data between RAM 0 and RAM 1 at time t₁, wherein a dotted line 30 shows a storing sequence between RAM 0 and RAM 1. As shown in FIG. 3A, a data x[n] corresponding to time t₁ is stored in a location indexed by address 2 in RAM 0, wherein the data x[n] is a current input signal received by the input device 210 at time t₁. A data x[n−1], which is a received data antecedent to the data x[n], is stored in a location indexed by address 1 in RAM 1, and a data x[n−2], which is a received data antecedent to the data x[n−1], is stored in a location indexed by address 1 in RAM 0. FIG. 3B shows a storing status of the received data between RAM 0 and RAM 1 at time t₂, which is a time after 3 cycles of the sampling frequency fₛ later than the time t₁. As shown in FIG. 3B, a data x[n] corresponding to time t₂ is stored in a location indexed by address 3 in RAM 1, wherein the data x[n] is a current input signal received by the input device 210 at time t₂. At the same time, the data x[n] corresponding to time t₁, which is stored in the location indexed by address 2 in RAM 0, will become a data x[n−3] corresponding to time t₂.

Referring to FIGS. 3A and 3B, the received data corresponding to the same coefficient are stored into different memories. For example, in FIG. 3B, the data x[n] and x[n−(N−1)], both corresponding to the coefficient a₀, are stored in RAM 1 and RAM 0, respectively. The data x[n−1] and x[n−(N−2)], both corresponding to the coefficient a₁, are stored in RAM 0 and RAM 1, respectively. In this embodiment, the memory sizes of RAM 0 and RAM 1 is equal to L. Hence, after the data x[n] is received by the input device 210 and stored into RAM 0 or RAM 1, the calculating device 230 can read all the data from RAM 0 and RAM 1 to generate the calculation values S₀-S_{L}. In one embodiment, the memory sizes of RAM 0 and RAM 1 is greater than L. Thus, the calculating device 230 can only read the N successively received data from RAM 0 and RAM 1 to generate the calculation values S₀-S_{L}, wherein the read data corresponding to the same coefficient are read from RAM 0 and RAM 1, respectively. In other words, the calculating device 230 reads the

$$\frac{N}{2}$$

received data of the N successively received data from RAM 0 and reads the other

$$\frac{N}{2}$$

received data of the N successively received data from RAM 1 during

$$\frac{N}{2}$$

cycles of the operation frequency f_{c}. Hence, the FIR filter of the invention will increase the speed of DSP arithmetic calculations without complicated circuits.

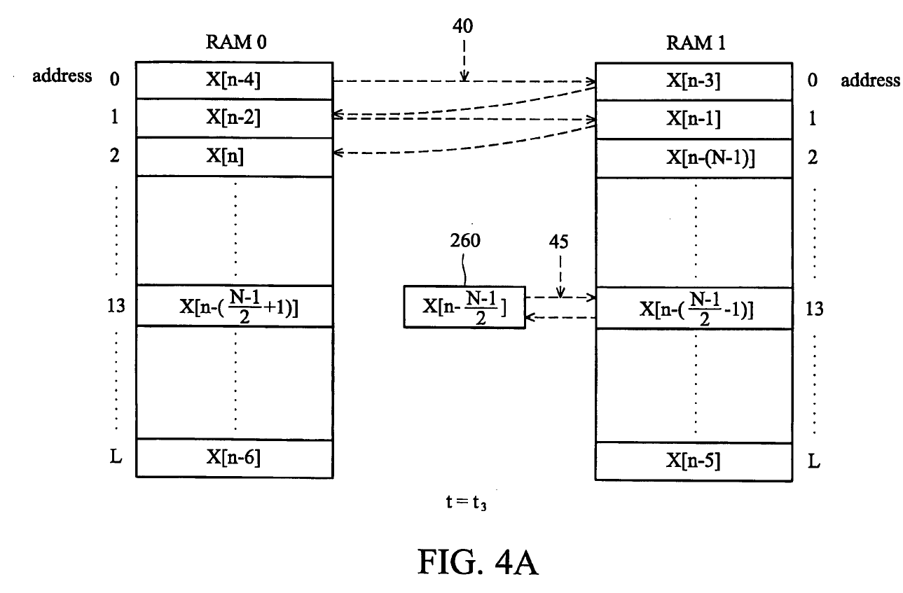

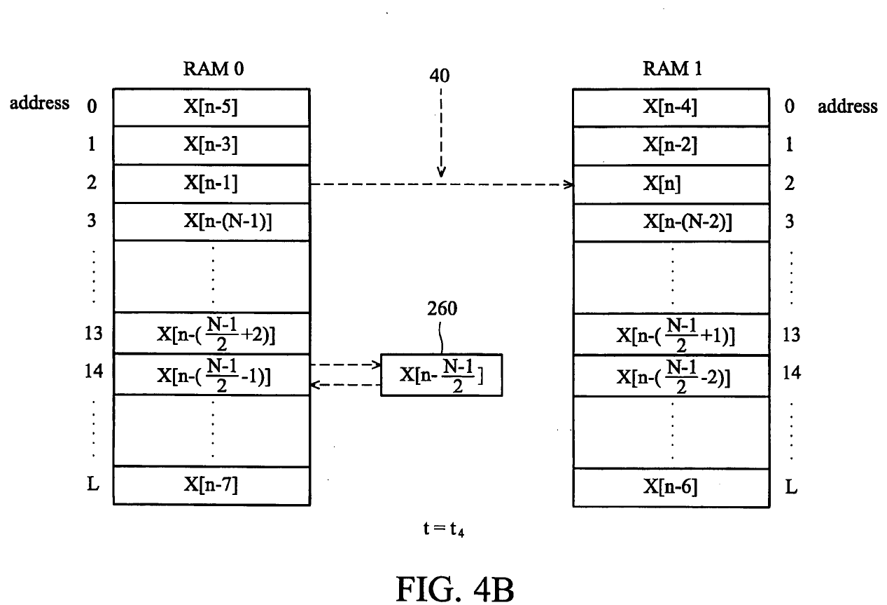

FIGS. 4A and 4B show a storing scheme of RAM 0 and RAM 1 when N is odd. FIG. 4A shows a storing status of the received data between RAM 0 and RAM 1 at time t₃, wherein a dotted line 40 shows a storing sequence between RAM 0 and RAM 1. As shown in FIG. 4A, a data x[n] corresponding to time t₃ is stored in a location indexed by address 2 in RAM 0, wherein the data x[n] is a current input signal received by the input device 210 at time t₃. As described above, the received data corresponding to the same coefficient are stored into different memories. For example, in FIG. 4A, the data x[n] and x[n−N−1)], both corresponding to the coefficient a₀, are stored into RAM 1 and RAM 0, respectively. The data

$$x [ n - ( \frac{N - 1}{2} + 1 ) ] and x [ n - ( \frac{N - 1}{2} - 1 ) ] ,$$

both corresponding to the coefficient a_{L}, are stored into the locations indexed by address 13 in RAM 0 and RAM 1 respectively, wherein L is equal to

$$( \frac{N - 1}{2} - 1 )$$

and address 13 is a example. In addition, the data

$$x [ n - \frac{N - 1}{2} ]$$

(i.e. the middle data) is stored in the register unit 260. In FIG. 4A, the memory sizes of RAM 0 and RAM 1 is equal to L. Hence, after the data x[n] is received by the input device 210 and stored into RAM 0 or RAM 1, the calculating device 230 can read the middle data from the register unit 260 and the data from RAM 0 and RAM 1 to generate the calculation values S₀-S_{L+1}, wherein the calculation value S_{L+1} (no shown in FIG. 2) is equal to the middle data corresponds to the asymmetric coefficient. Next, the calculating device 240 multiples the calculation values S₀-S_{L+1} and the corresponding coefficients a₀-a_{L+1} to generate a plurality of calculation values M₀-M_{L+1}, respectively. Finally, the calculating device 250 accumulates the calculation values M₀-M_{L+1} to generate the output signal y[n]. In one embodiment, the memory sizes of RAM 0 and RAM 1 is greater than L. Thus, the calculating device 230 can only read the N successively received data from RAM 0, RAM and the register unit 260 to generate the calculation values S₀-S_{L+1}. In fact, the calculating device 230 reads the

$$\frac{N - 1}{2}$$

received data of the N successively received data from RAM 0 and reads the

$$\frac{N - 1}{2}$$

received data of the N successively received data from RAM 1 during

$$\frac{N - 1}{2}$$

cycles of the operation frequency f_{c}.

FIG. 4B shows a storing status of the received data between RAM 0 and RAM 1 at time t₄, which is a time after 1 cycle of the sampling frequency fₛ later than the time t₃. As shown in FIG. 4B, a data x[n] corresponding to time 14 is stored in a location indexed by address 2 in RAM 1, wherein the data x[n] is a current input signal received by the input device 210 at time t₄. Similarly, the data x[n] corresponding to time t₃, which is stored in the location indexed by address 2 in RAM 0, will become a data x[n−1] corresponding to time t₄. After the current input signal is sampled and stored according to the sampling frequency fₛ at time t₄, a middle data corresponding to the current input signal, which is stored in the locations indexed by address 13 in RAM 1 at time t₃, is swapped with the middle data corresponding to the last input signal, which is stored in the register unit 260 at time t₃, as shown in a dotted line 45 of FIG. 4A.

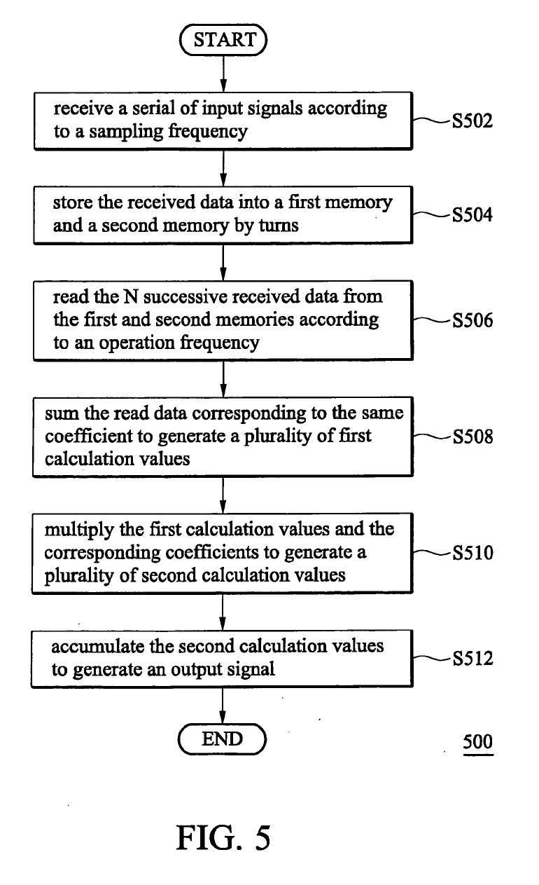

FIG. 5 shows a method 500 for implementing an N-order FIR filter with a symmetric coefficient set according to an embodiment of the invention. First, in step 502, a serial of input signals are received according to a sampling frequency. Next, the received data are stored into a first memory and a second memory by turns (step 504). Then, in step S506, the N successively received data are read from the first and second memories according to an operation frequency, wherein each read data corresponds to a coefficient of the symmetric coefficient set. Next, in step S508, the read data corresponding to the same coefficient are summed to generate a plurality of first calculation values, respectively. Then, the first calculation values are separately multiplied with the corresponding coefficients to generate a plurality of second calculation values in step S510. Finally, in step S512, the second calculation values are accumulated to generate an output signal.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An N-order finite impulse response (FIR) filter with a symmetric coefficient set, comprising:
first and second memories;
an input device for receiving a serial of input signals according to a sampling frequency and storing the received data into the first and second memories by turns;
a first calculating device for reading the N successively received data from the first and second memories according to an operation frequency and generating a plurality of first calculation values, wherein each of the read data corresponds to a coefficient of the symmetric coefficient set and the first calculation value is generated by summing the read data corresponding to the same coefficient;
a second calculating device for, generating a plurality of second calculation values, wherein the second calculation value is generated by multiplying the first calculation value and the corresponding coefficient; and
a third calculating device for accumulating the second calculation values to generate an output signal.

2. The FIR filter as claimed in claim 1, wherein the operation frequency divided by the sampling frequency is greater than or equal to N.

3. The FIR filter as claimed in claim 1, wherein the read data corresponding to the same coefficient are read from the first and second memories, respectively.

4. The FIR filter as claimed in claim 3, wherein the first calculating device reads the
$$\frac{N}{2}$$
received data of the N successively received data from the first memory and reads the
$$\frac{N}{2}$$
received data of the N successively received data from the second memory during
$$\frac{N}{2}$$
cycles of the operation frequency when N is even.

5. The FIR filter as claimed in claim 3, wherein the first calculating device reads the
$$\frac{N - 1}{2}$$
received data of the N successively received data from the first memory and reads the
$$\frac{N - 1}{2}$$
received data of the N successively received data from the second memory during
$$\frac{N - 1}{2}$$
cycles of the operation frequency when N is odd.

6. The FIR filter as claimed in claim 5, further comprising a register unit for storing a middle data when N is odd, wherein the middle data is a
$$( \frac{N + 1}{2} ) th$$
data of the N successively received data, and wherein the middle data corresponds to an asymmetric coefficient.

7. The FIR filter as claimed in claim 6, wherein a next middle data stored in the first or second memories is swapped with the middle data stored in the register unit according to the sampling frequency, wherein the next middle data is data subsequent to the middle data among the N successively received data.

8. The FIR filter as claimed in claim 1, wherein the first and second memories are the same type of memories.

9. A method for implementing an N-order finite impulse response (FIR) filter with a symmetric coefficient set, comprising:
receiving a serial of input signals according to a sampling frequency;
storing the received data into a first memory and a second memory by turns;
reading the N successively received data from the first and second memories according to an operation frequency, wherein each of the read data corresponds to a coefficient of the symmetric coefficient set;
summing the read data corresponding to the same coefficient to generate a plurality of first calculation values, respectively;
multiplying the first calculation values and the corresponding coefficients to generate a plurality of second calculation values, respectively; and
accumulating the second calculation values to generate an output signal.

10. The method as claimed in claim 9, wherein the operation frequency divided by the sampling frequency is greater than or equal to N.

11. The method as claimed in claim 9, wherein the read data corresponding to the same coefficient are read from the first and second memories, respectively.

12. The method as claimed in claim 11, wherein if N is even, reading the N successively received data further comprises:
reading the
$$\frac{N}{2}$$
received data of the N successively received data from the first memory and reading the
$$\frac{N}{2}$$
received data of the N successively received data from the second memory during
$$\frac{N}{2}$$
cycles of the operation frequency.

13. The method as claimed in claim 11, wherein if N is odd, reading the N successively received data further comprises:
reading the
$$\frac{N - 1}{2}$$
received data of the N successively received data from the first memory and reading the
$$\frac{N - 1}{2}$$
received data of the N successively received data from the second memory during
$$\frac{N - 1}{2}$$
cycles of the operation frequency.

14. The method as claimed in claim 13, wherein reading the N successively received data further comprises:
storing a middle data into a register unit,
wherein the middle data is a
$$( \frac{N + 1}{2} ) th$$
data of the N successively received data, and wherein the middle data corresponds to an asymmetric coefficient.

15. The method as claimed in claim 14, wherein reading the N successively received data further comprises:
swapping a next middle data stored in the first or second memories with the middle data stored in the register unit according to the sampling frequency,
wherein the next middle data is data subsequent to the middle data among the N successively received data.

16. The method as claimed in claim 9, wherein the first and second memories are the same type of memories.
